(19) United States
(12) Patent Application Publication
(10) Pub. No.: US 2011/0000733 A1
(43) Pub. Date: Jan. 6, 2011

(54) ENHANCING TIRE PERFORMANCE UTILIZING RELEASABLE ELEMENTS

(75) Inventors: Keith S. Snavely, Sterling Heights, MI (US); Jerome Joseph Moleski, Clinton Township, MI (US); Jon T. Carter, Farmington, MI (US)

Correspondence Address: SLJ, LLC, 324 E. 11th St., Ste. 101, Kansas City, MO, 64106, US

(73) Assignee: GM GLOBAL TECHNOLOGY OPERATIONS, INC., Detroit, MI (US)

(21) Appl. No.: 12/497,647

(22) Filed: Jul. 4, 2009

(51) Int. Cl. B60R 21/00; B60C 11/00

(52) U.S. Cl. 180/271; 152/209.4

(57) ABSTRACT

An adaptive tire employable by a vehicle traveling upon a surface, including a releasable element operable to selectively modify a performance characteristic of the tire, such as traction, and methods of enhancing the performance of a tire by selective introduction of a substance.

### BACKGROUND OF THE INVENTION

1. Field of the Invention

The present disclosure generally relates to tires, such as automobile tires, and more particularly to methods of enhancing tire performance using releasable elements.

2. Discussion of Prior Art

Properly functioning tires are important to ensure health and safety during the operation of a vehicle. Among the most important performance characteristics associated therewith is traction, which is the kinematic friction force defined by the tire and road (or otherwise surface) when the vehicle is in motion. It is appreciated that a minimum amount of traction is necessary to dynamically absorb gravitational, centripetal, and/or braking forces. Concernedly, however, it is well known that various ambient and inherent conditions have adverse impacts upon traction, including, for example, low tire tread (in certain instances), hyper-inflated tires, and the presence of rain, snow, ice, and other foreign substances. Even in the absence of these conditions, the amount of traction necessary varies under differing vehicular conditions (e.g., loading, speed, incline slope, etc.). Despite the need to maintain proper traction under varying conditions, conventional tires typically present non-adaptive solutions.

### BRIEF SUMMARY

The present invention concerns an adaptive or “smart” tire that is able to autonomously adjust a performance characteristic, and primarily the traction defined between the tire and riding surface, in response to an ambient or inherent condition. As such, the invention is useful for expanding the range of safe operation. The invention, especially in an automotive setting, is further useful for increasing fuel economy through the selective increase in traction.

In the instant disclosure, the inventive tire is employable by a vehicle traveling upon a surface, comprises a first structural component configured to engage the surface along a face, and is adapted to selectively change the performance characteristic. With respect to the latter, the tire is formed of at least one releasable element inter-engaged with the component. The releasable element is in operative communication with, and configured to be selectively released, so as to modify the performance characteristic. In a second aspect of the invention, a method of adjusting a performance characteristic, such as traction, includes the release of at least one element onto the tire or into the contact patch. Various configurations of the smart tire, including suitable releasable substances, are provided.

The above described and other features are exemplified by the following figures and detailed description.

### BRIEF DESCRIPTION OF THE DRAWINGS

Preferred embodiments of the invention are described in detail below with reference to the attached drawing figures of exemplary scale, wherein:

FIG. 1 is an elevation of a vehicle traveling upon a surface and having smart tires and/or defining substance releasing orifices, in accordance with a preferred embodiment of the invention;

FIG. 2 is a perspective view of a smart tire having embedded releasable elements, in accordance with a preferred embodiment of the invention;

FIG. 3 is a cross-sectional view of a smart tire, particularly illustrating the releasable elements and structure of the tire, including heating elements interengaged with the releasable elements, in accordance with a preferred embodiment of the invention;

FIG. 4a is a partial elevation of a smart tire having a plurality of releasable microcapsules carrying a performance enhancing substance impregnated within the tire material, wherein a first quantity of substance has been released, in accordance with a preferred embodiment of the invention;

FIG. 4b is an elevation of the tire shown in FIG. 4a, wherein a larger quantity of substance has been released; and

FIG. 4c is an elevation of a smart tire having a plurality of releasable microcapsules carrying first and second agents impregnated within the tire material, wherein a quantity of each agent has been released and the released agents have combined to form the performance enhancing substance adjacent the roadway surface, in accordance with a preferred embodiment of the invention.

### DETAILED DESCRIPTION

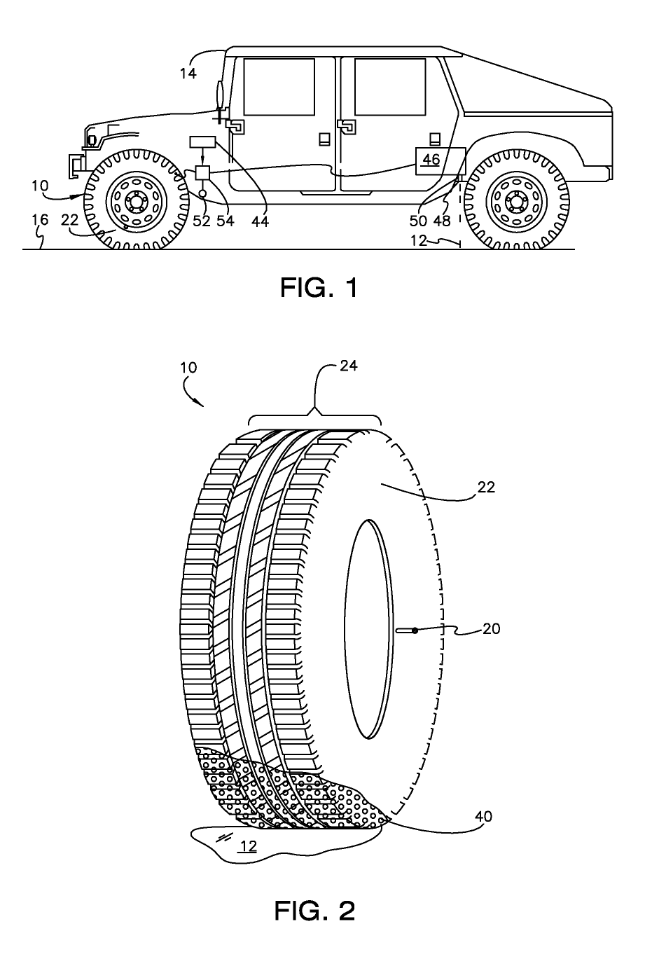

The present invention concerns plural methods of enhancing tire performance generally utilizing releasable elements, and smart tires 10 employing the same. In general, the inventive tires 10, described and illustrated herein are operable to selectively release a performance enhancing substance 12 under desired ambient and inherent vehicular conditions (FIGS. 1-4c). The advantages and benefits of the invention may be used in various types of transportation vehicles (e.g., with respect to bicycles, aviation, etc.), but is more particularly suited for use with an automotive vehicle 14 (e.g., motorcycle, car, truck, SUV, all-terrain vehicle, etc.), wherein said vehicle 14 travels upon a surface 16.

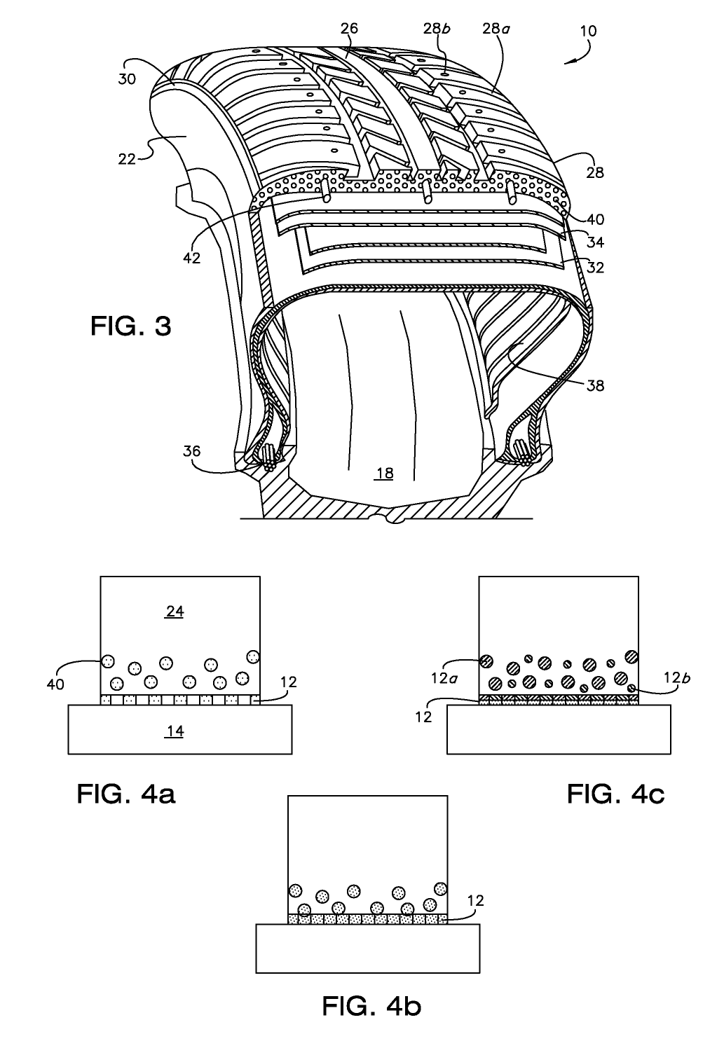

As best shown in FIGS. 2 and 3, the inventive modifications are adapted for use with an otherwise conventional elastomeric (e.g., synthetic and/or natural rubber) tire that defines an interior region when mounted upon a wheel 18. A valve assembly 20 enables compressed air to enter the region, so as to inflate the tire 10 to an operative state. The tire 10 itself is formed by a plurality of structural components, including first and second opposite sidewalls 22 interconnected by a treadwall 24. More particularly, and as shown in FIG. 3, the tire 10 may be of the type having a treadwall 24 consisting essentially of a central rib 26, and tread elements 28 (or “blocks”). The tread elements 28 define grooves 28a and sipes 28b that cooperatively from a tread pattern and depth that contribute to the traction. The treadwall 24 preferably presents chamfered or rounded lateral shoulders 30 that transition into the outer periphery of the sidewalls 22.

Underneath the tread elements 28, a layer of reinforcing belts or piles 32 typically formed of steel, add structural stability and puncture resistance to the treadwall 24. Cap piles 34 are optionally provided intermediate the elements 28 and reinforcing belts 32 for added security. The sidewalls 22 provide lateral stability to the tire 10 and together with the compressed air transfers the weight of the vehicle 12 to the surface 14. As shown in FIG. 1, it is appreciated that the sidewalls 22 undergo deformation as the tire 10 rolls. Finally, bead bundles 36 typically consisting of a plurality of wires run within bead chaffers defined along the inner radius of the tire 10. The bundle 36 provides structural strength and stiffness at this location, which among other things enables the tire 10 to stay mounted onto the wheel 18. Finally an interior liner 38 further protects the tire 10. It is appreciated that the afore-described tire 10 is described for exemplary purposes only, such that the present invention may be used with various tire configurations not described herein.

In a preferred embodiment of the invention, rubber compound formulations are used to construct the tread elements 28, and include a microencapsulated performance enhancing substance 12. The formulations and geometric configurations of the elements 28 are cooperatively configured such that the substance 12 releases rapidly under predetermined passive conditions. For example, the substance 12 may be released under extreme acceleration, hard cornering, or severe braking. FIGS. 4a-c schematically show a plurality of microcapsules 40 disposed at or near the face of a tread element 28, wherein a portion of which have been breached; however, it is appreciated that a singular void (not shown), lesser plurality of longitudinal channels (also not shown), or other configurations may be used to store the substance 12.

Once released, the substance 12 is configured to rapidly act to increase traction between the tire 10 and roadway surface 16, and in one embodiment is chemically reactive with the tread material and/or surface 16. The microcapsules 40 and tread elements 28 may be cooperatively configured so that the substance 12 is released externally, or just under the exterior face of the elements 28. It is appreciated that the microcapsules 40 may be formed by the tire material itself. That is to say, the substance 12 may be store in a plurality of pockets defined at or near the face of the treadwall 24.

A suitable substance 12 is a liquid that locally softens the exterior face of the tread elements 28. To that end, it is appreciated that sodium hypochlorite or stabilized hydrogen peroxide of varying dilutions may be used. Other suitable active oxidizing materials include benzoyl peroxide, dicumyl peroxide, or any oxide that has an activation temperature within the anticipated operating temperature range. Solvents suitable for use present a vapor pressure high enough to remain in liquid form long enough to soften the tread 28, and include toluene, ethyl benzene, and paramethyl toluene. Alternatively, a “sticky” substance 12 that binds or adheres to the tread material (e.g., rubber) and/or asphalt/concrete may be used. Lastly, it is appreciated that the substance 12 must be environmentally safe.

In a second embodiment, the microcapsules 40 carry differing agents (or reactants) 12a,b that when inter-mixed react to form the performance enhancing substance 12. In FIG. 4c, two different agents (e.g., an adhesive resin and an adhesive hardener, a solid and a solvent, etc.) are shown; however, it is certainly within the ambit of the invention to utilize a greater plurality of agents. Moreover, in certain conditions, such as winter weather conditions, it may be desirable to produce a solute, such as salt (not shown), that further separates from the substance 12. Finally, it is appreciated that biological oxidizers, such as Managanese peroxidase and laccase, may also be utilized.

In one example, the agents 12a,b are released at a higher rate of speed or under extreme conditions that result in higher temperatures and shear stresses at the face of the tread wall 24. That is to say, the tread elements 28 and microcapsules 40 may be cooperatively configured so that elevated temperatures and stresses, but not normal operating temperatures and stresses, cause the shells of the microcapsules 40 to rupture.

It is appreciated that tire treads 28 made with such formulations would be particularly useful on vehicles 14, which do not have anti-lock braking systems, as these vehicles typically experience greater shear stresses when undergoing locking conditions. Finally, it is also appreciated that the release of the substance 12 may be caused or facilitated by thermal heat energy; and to that end, the tire 10 may further include on-demand heating elements 42 operable to selectively heat the treadwall 24. For example, and as shown in FIGS. 1 and 3, a plurality of resistively heated wires may be circumferentially inserted within the treadwall 24 and electrically coupled to a power source 44.

In a second aspect of the invention, an alternative method of releasing the performance enhancing substance 12 directly onto the tire 10, or upon the surface 16 immediately fore the contact patch defined by the tire 10 and roadway surface 16 is presented. As shown in FIG. 1, the substance 12 may be stored in a reservoir 46 composing the vehicle 12. For example, a reservoir 46 may be positioned just fore the tires 10 and fluidly coupled to at least one orifice 48 preferably via a pump 50. The pump 50 and orifice 48 are cooperatively configured to direct a jet of substance 12 either directly into the patch or upon the treadwall 24 approaching the patch. The reservoir may be positioned atop the tire 10 and configured to dispense substance 12 at a controlled rate due to gravity. Here, a door may be used to selectively enable release. The orifice 48 is preferably located and configured to direct a liquid substance 12 towards the rib 26 or lateral centerline of the tire 10, as it is appreciated that the tread elements 28 are typically configured to disperse liquids laterally.

In operation, when the vehicle 12 achieves a predetermined condition, the tire 10 is configured to autonomously effect release, or an actuation signal is delivered to the resistive elements 42, pump 50, or door to cause or enable release. A preferred condition is the exceedance of a predetermined speed (e.g., 50 mph), a minimum shear stress defined by the face and surface 16, or the beginning of slippage between the face and surface 16. As such, the vehicle 12 preferably includes at least one sensor (e.g., speedometer, wheel speed sensor, etc.) 52 operable to detect the condition, and a controller 54 communicatively coupled to the sensor 52 and tire 10 and operable to effect release only when the condition is detected. More preferably, the degree of release is proportional to the condition (e.g., speed of the vehicle), such that a greater amount of substance 12 is released at higher speeds, etc. For example, the heating element 42 may be caused to produce a greater amount of heat more rapidly as the speed increases. When the vehicle condition completely stops (e.g., the speed is reduced past a minimum threshold), the passive releasing force, or signal from the controller 54 is ceased. The process may be repeated until the quantity of stored substance 12 is depleted.

As used herein, the terms “first”, “second”, and the like do not denote any order or importance, but rather are used to distinguish one element from another, and the terms “the”, “a”, and “an” do not denote a limitation of quantity, but rather denote the presence of at least one of the referenced item. Furthermore, all ranges directed to the same quantity of a given component or measurement is inclusive of the endpoints and independently combinable.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A tire adapted for use with a vehicle traveling upon a surface and for selectively enhancing a performance characteristic, said tire comprising:
a first structural component configured to engage the surface along a face, wherein the component and/or surface define a first performance characteristic value; and
at least one releasable element inter-engaged with the component, in operative communication with, and configured to be selectively released upon the surface, so as to modify the performance characteristic to a second value.

2. The tire claimed in claim 1, wherein the element includes at least one microcapsule filled with at least one substance, and said at least one microcapsule and material being cooperatively configured to cause the microcapsule to rapidly release upon the occurrence of a predetermined condition.

3. The tire claimed in claim 2, wherein said at least one substance is released within the component proximate the face.

4. The tire claimed in claim 2, wherein said at least one substance is a traction-enhancing substance, and the condition is selected from the group consisting of severe braking, hard cornering, and extreme accelerating.

5. The tire claimed in claim 4, wherein the component is formed of a hard rubber, and the substance is a liquid operable to soften the rubber when engaged therewith.

6. The tire claimed in claim 4, wherein said at least one substance is selected from the group consisting of sodium hypochlorite, hydrogen peroxide, benzoyl peroxide, dicumyl peroxide, toluene, ethyl benzene, paramethyl toluene, biological oxidizers, and a combination thereof.

7. The tire claimed in claim 4, wherein a plurality of microcapsules individually contain a plurality of differing agents, and the agents are cooperatively configured to react and produce the substance, when inter-mixed.

8. The tire claimed in claim 7, wherein the agents are cooperatively configured to further produce a precipitate.

9. The tire claimed in claim 7, wherein the agents are an adhesive resin and an adhesive hardener.

10. The tire claimed in claim 7, wherein the agents are a solid and a solvent.

11. The tire claimed in claim 2, wherein the condition is the exceedance of a predetermined speed, a minimum shear stress defined by the face and surface, or the beginning of slippage at the face and surface.

12. The tire claimed in claim 1, further comprising:
at least one heating element operable to heat the component and/or releasable element, wherein the heating element and/or component are configured to release the releasable element when heated to a predetermined temperature.

13. A vehicle adapted for traveling upon a surface, said vehicle comprising:
at least one tire presenting a performance characteristic defined by the tire;
a reservoir of substance operable to enhance the characteristic, when caused to contact the tire; and
a releasing mechanism fluidly coupled to the reservoir and operable to selectively release at least a portion of the substance either directly upon the tire, upon the surface immediately fore the tire, or within the contact patch cooperatively defined by the tire and surface.

14. The vehicle claimed in claim 13, further comprising:
a sensor operable to detect a vehicular condition;
a controller communicatively coupled to the sensor and mechanism, and operable to cause the mechanism to release said at least portion when the condition is detected.

15. The vehicle as claimed in claim 14, wherein the condition is a predetermined speed.

16. A method of selectively enhancing a performance characteristic of a tire adapted for use with a vehicle traveling upon a surface, said method comprising:
a. securing a quantity of substance relative to the tire and surface, wherein the substance is operable to enhance the characteristic upon contacting the tire and/or surface;
b. autonomously determining a condition; and
c. autonomously causing at least a portion of the quantity of substance to be released either directly onto the tire, or upon the surface immediately fore the contact patch defined by the tire and surface, when the condition is determined.

17. The method claimed in claim 16, wherein step a) includes the step of storing the quantity in a reservoir composing the vehicle and coupling the reservoir to an orifice defined near the tire.

18. The method claimed in claim 17, wherein step c) further includes the step of actuating a pump fluidly coupled to the reservoir, or exposing the quantity to gravity.

19. The method claimed in claim 16, wherein the tire defines a tread pattern, and step c) further includes the steps of releasing said at least portion onto the centerline of the tire, and allowing the pattern to disperse the substance.
